(19) United States
(12) Patent Application Publication
(10) Pub. No.: US 2024/0089316 A1
(43) Pub. Date: Mar. 14, 2024

(54) LIVE DEMONSTRATION ASSISTANCE PROVIDING MORE RELIABLE OUTPUT

(71) Applicant: International Business Machines Corporation, Armonk, NY (US)

(72) Inventors: Jie Yang, Beijing (CN); Zhun Huang, Beijing (CN); Xiang Juan Meng, Beijing (CN); Cheng Fang Wang, Shangdi (CN)

(73) Assignee: International Business Machines Corporation, Armonk, NY (US)

(21) Appl. No.: 17/943,411

(22) Filed: Sep. 13, 2022

(51) Int. Cl. H04L 67/1008

(52) U.S. Cl. CPC H04L 67/1008; G06Q 30/01

(57) ABSTRACT

A method for providing more reliable output when conducting a live product demonstration is disclosed. In one embodiment, such a method initiates, on a client system, a live product demonstration by executing a function on a live demonstration server. In the event the function fails, the method saves a breakpoint associated with the live product demonstration. The method checks the availability of a standby demonstration server. In the event the standby demonstration server is available, the method automatically continues, from the breakpoint, the live product demonstration by executing the function on the standby demonstration server. If the standby demonstration server is not available, the method may return an error message to the client system. In the event the live demonstration server is recovered, the method may resume the live product demonstration by executing the function on the live demonstration server. A corresponding system and computer program product are also disclosed.

### BACKGROUND

### Field of the Invention

This invention relates to systems and methods for providing more reliable output when conducting a live product demonstration.

### Background of the Invention

When trying to sell or market a product to a prospective or existing customer, live product demonstrations may provide a valuable tool. Effective product demonstrations can help a company or salesperson close more deals and/or stand out from the competition. Among other benefits, live product demonstrations may provide prospective customers the opportunity to see what a product can do for them, how easy the product is to use in different scenarios, and the various features and functions of the product. In certain cases, a live product demonstration can be tailored to a customer's specific needs to show the customer how the product can specifically address those needs. This may help the customer see the potential value of the product in the context of their own business.

On the other hand, if a live product demonstration goes awry or malfunctions, a customer's opinion of a product may be negatively impacted. In some cases, a sale or opportunity to place the product may be lost. In some cases, a live product demonstration may rely on technology such as a server, computer system, software product, or other supporting technology to function correctly. If a failure or glitch occurs in the supporting technology that interrupts or causes a malfunction of the live product demonstration, the benefits of the product may not be exhibited or observed. In some cases, the reputation or standing of the product may be harmed.

### SUMMARY

The invention has been developed in response to the present state of the art and, in particular, in response to the problems and needs in the art that have not yet been fully solved by currently available systems and methods. Accordingly, systems and methods have been developed for providing more reliable output when conducting live product demonstrations. The features and advantages of the invention will become more fully apparent from the following description and appended claims, or may be learned by practice of the invention as set forth hereinafter.

Consistent with the foregoing, a method for providing more reliable output when conducting a live product demonstration is disclosed. In one embodiment, such a method initiates, on a client system, a live product demonstration by executing a function on a live demonstration server. In the event the function on the live demonstration server fails, the method saves a breakpoint associated with the live product demonstration. The method checks the availability of a standby demonstration server. In the event the standby demonstration server is available, the method automatically continues, from the breakpoint, the live product demonstration by executing the function on the standby demonstration server. If the standby demonstration server is not available, the method may return an error message to the client system. In the event the live demonstration server is recovered, the method may resume the live product demonstration by executing the function on the live demonstration server.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a process flow diagram showing one embodiment of a method for setting up a system in accordance with the invention;

FIG. 3 is a high-level block diagram showing various tables that may be included in a server action registry database in accordance with the invention;

FIGS. 4 and 5 show a process flow diagram of one embodiment of a method for providing more reliable output when conducting a live product demonstration;

FIG. 6 is a process flow diagram showing interaction between various components of a system in accordance with the invention; and

FIG. 7 is a high-level block diagram showing interaction between various components of a system in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., a “live demonstration assistance module 150”) associated with providing more reliable output when conducting a live product demonstration. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

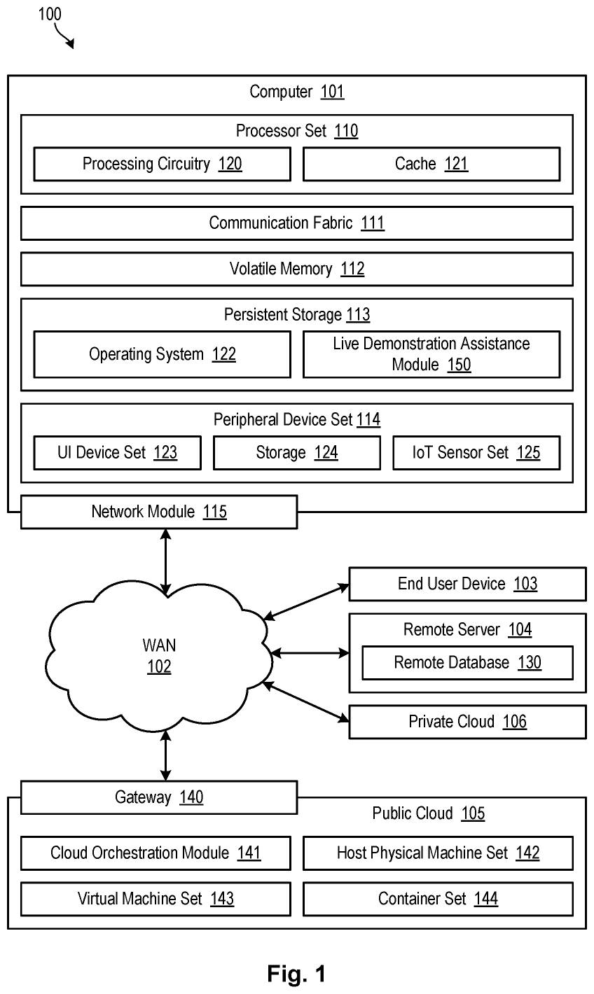

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

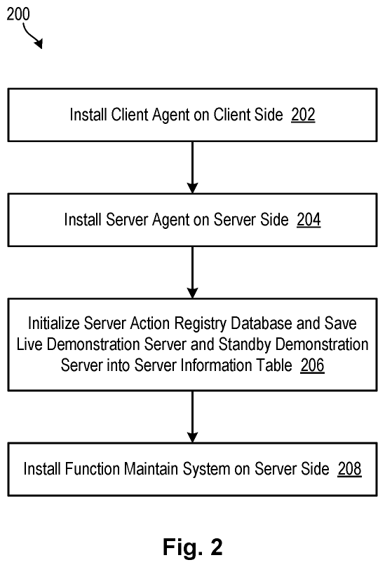

Referring to FIG. 2, as previously mentioned, when trying to sell or market a product to a prospective or existing customer, product demonstrations may provide a valuable tool. Effective product demonstrations can help a company or salesperson close more deals and/or stand out from the competition. Among other benefits, live product demonstrations may provide prospective customers the opportunity to see what a product can do for them, how easy the product is to use in different scenarios, and the various features and functions of the product. In certain cases, a live product demonstration can be tailored to a customer's specific needs to show the customer how the product can specifically address those needs. This may help the customer see the potential value of the product in the context of their own business.

On the other hand, if a live product demonstration goes awry or malfunctions, a customer's opinion of a product may be negatively affected. For example, a product (e.g., software) that is being shown may not be fully tested or developed at the time it is demonstrated, increasing the chances for something to go wrong. As a result, the product may not operate as smoothly or seamlessly as desired. If something does malfunction and the customer's opinion is negatively impacted, a sale or opportunity to place the product may be lost.

In some cases, a live product demonstration may rely on technology such as a server, computer system, software product, or other supporting technology to function correctly. If a failure or glitch occurs in the supporting technology that interrupts or causes a malfunction of the live product demonstration, the benefits of the product may not be exhibited or observed. In some cases, the reputation or standing of the product may be harmed.

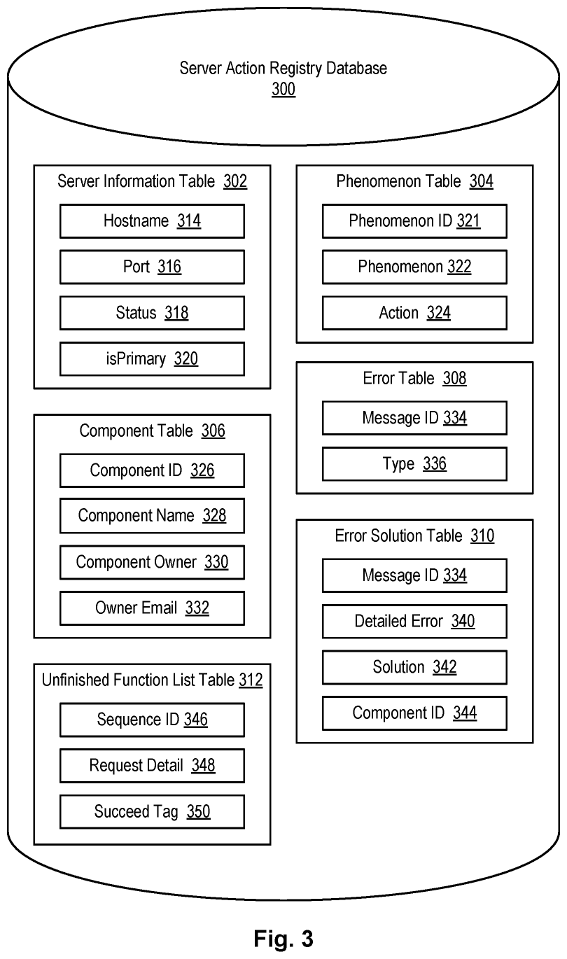

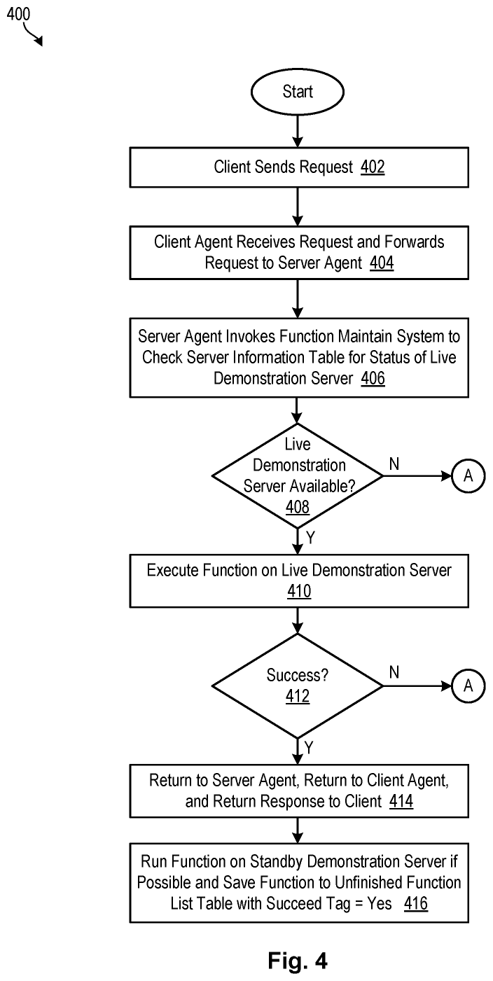

FIG. 2 shows one embodiment of a method 200 for setting up a system 710 for providing more reliable output (e.g., visual appearance, data output, etc.) when conducting live product demonstrations. In referring to FIG. 4, general reference is also made to FIGS. 3, 6, and 7. As shown in FIG. 2, the method 200 installs 202 a client agent 602 on a client side 700 and installs 204 a server agent 604 on a server side 702. The method 200 then initializes 206 a server action registry database 300 (See FIG. 3) and saves 206 a reference to a live demonstration server 704 and standby demonstration server 706 into a server information table 302 of the server action registry database 300. The method 200 then installs 208 a function maintain system 606 on the server side 702. The function and purpose of the installed components will be described in more detail hereafter.

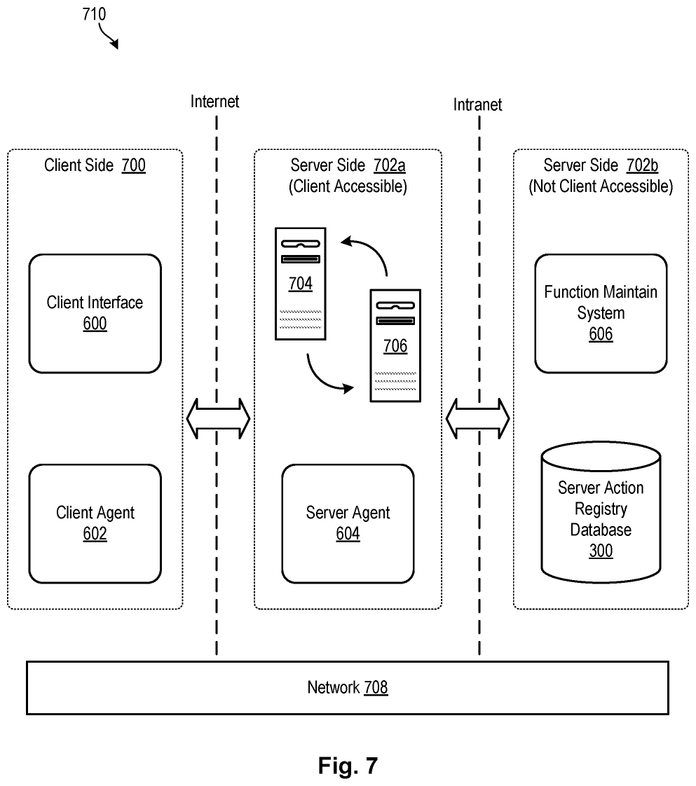

In general, the system 710 shown in FIG. 7 may be used to help a live product demonstration run more smoothly with fewer failures and/or malfunctions. As shown in FIG. 7, the system 710 includes a live demonstration server 704 and standby demonstration server 706. In certain embodiments, the live demonstration server 704 is a latest server that has most recent and updated functionality. The standby demonstration server 706, by contrast, may be a stable server that has been tested but may not include the latest and most updated functionality that is on the live demonstration server 704, and thus may not have all the functionality that is desired by a customer. When a function executes on the live demonstration server 704, the system 710 may save a breakpoint and context information (e.g., parameters) associated with the function. In this way, if the live product demonstration fails, the system 710 can switch the live product demonstration to a standby demonstration server 706 and continue from the breakpoint. Also, the system 710 may assist in switching back to the live demonstration server 704 when the live demonstration server 704 recovers.

As shown in FIG. 7, on a client side 700, the system 710 includes a client interface 600 (e.g., a live demonstration interface) and the client agent 602. The client interface 600 may enable a client to execute a particular function (e.g., software) on the system 710 and provide an interface for interacting with the function, such as inputting or outputting data. In certain embodiments, the function may be tailored to the customer's particular enterprise or business. The client interface 600 may, in certain embodiments, include a browser, applet, or the like, to interface with the function.

The client agent 602 may execute on the client side 700 to check network and server-side availability and provide feedback to the client interface 600. Based on a “check policy,” the client agent 602 may maintain communication with backend components (e.g., the server agent 604) until the client agent 602 receives a response to a request. The “check policy” may define a policy of network checking and server-side checking and associated updates and feedback to the client interface 600.

The server action registry database 300 may be resident on the server side 702 and record server-side errors and relative actions to be performed in response to the errors. The server agent 604 may execute on the server side 702 and monitor for client-side requests. The server agent 604 may relay these requests to the function maintain system 606 which may respond by invoking a function on the live demonstration server 704 and/or standby demonstration server 706. If the live demonstration server 704 and/or standby demonstration server 706 reports an error when executing the function, the function maintain system 606 may perform actions that are designated in the server action registry database 300 for the particular error. When the function maintain system 606 performs different actions, the server agent 604 may be informed and attempt to notify the client agent 602. The server agent 604 may also, in certain embodiments, check the network 708 and other underlying functionality to make sure the client agent 602 actually receives any responses or notifications send by the server agent 604.

As discussed above, system 710 includes the function maintain system 606 on the server side 702. The function maintain system 606 may include functionality specifically intended to maintain functionality across failures or malfunctions in the live demonstration server 704 and/or standby demonstration server 706. For example, the function maintain system 606 may automatically switch between the live demonstration server 704 and standby demonstration server 706 when failures or malfunctions occur to maintain continuity and smoothness in the execution of a live product demonstration. In performing its various functions, the function maintain system 606 may access various tables and associated data in the server action registry database 300, which will be discussed in more detail hereafter.

As shown, the server side 702 may include a first portion 702a that is accessible to the client 700, such as through the Internet, and a second portion 702b that is inaccessible to the client 700 but may nevertheless communicate with the first portion 702a. For example, a client 700 may be able to access the live demonstration server 704 and standby demonstration server 706 as well as the server agent 604, but not have access to the function maintain system 606 or server action registry database 300. Nevertheless, the server agent 604, live demonstration server 704, and standby demonstration server 706 may be accessible to the function maintain system 606 and server action registry database 300 and vice versa.

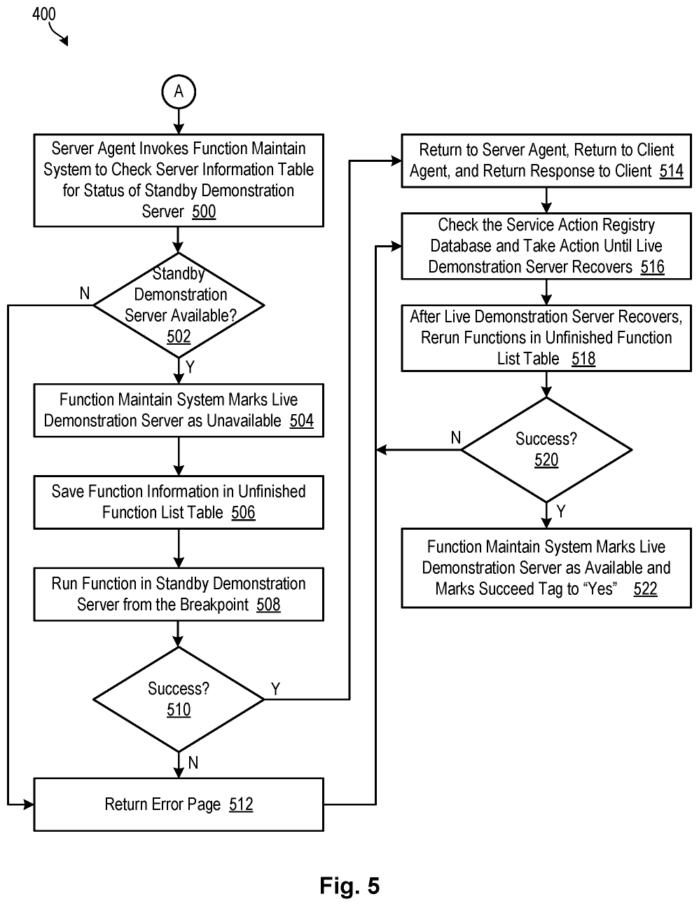

FIG. 3 shows various tables that may be included in a server action registry database 300 in accordance with the invention. As shown, the server action registry database 300 includes one or more of a server information table 302, phenomenon table 304, component table 306, error table 308, error solution table 310, and unfinished function list table 312. Various exemplary columns are shown in FIG. 5 for each of these tables 302, 304, 306, 308, 310, 312.

Columns of the server information table 302 may includes a host name 314, port 316, and status 318 (i.e., available/unavailable) for each of the live demonstration server 704 and standby demonstration server 706. The server information table 302 may also include an “isPrimary” indicator for each of the live demonstration server 704 and standby demonstration server 706 that indicates which server is the latest server that has the most recent and updated functionality.

Columns of the phenomenon table 304 may include phenomena identifiers 321, phenomenon descriptions 322 (e.g., hang, crash, error, etc.) that are associated with the phenomenon identifiers 321, and associated actions 324 (e.g., restart, etc.) to take in response to the phenomena in order to recover a server 704, 706. Columns of the component table 306 may include a component identifier 326, component name 328, component owner 330, and an email address 332 associated with the component owner 330. In some situations, when a component (e.g., the live demonstration server 704 or standby demonstration server 706) experiences a failure or malfunction, it may desirable to send a notification (e.g., email) to the component owner. The owner email address 332 may enable this to happen.

The error table 308 may provide more detailed information about the phenomena described in the phenomenon table 304. For example, columns of the error table 308 may include an error message identifier 334 (e.g., error code) associated with a particular error and a type 336 may identify the type of error (e.g., code error, server error, configuration error, etc.). The error solution table 310, by contrast, may contain the error message identifier 334, detailed error information 340, solution 342, and component identifier 344. This information may enable recovery of a particular component 344 (e.g., server 704, 706) from an error 334, 340 by applying the designated solution 342.

The unfinished function list table 312 may contain a list of functions that have not finished executing on the primary server (i.e., the latest server that contains the most recent and updated functions, typically the live demonstration server 704). This table includes a sequence identifier 346 to identify the function, a request detail 348, and a succeed tag 350. The succeed tag 350 may only be marked “yes” when a particular unfinished function has successfully executed on the latest server, typically the live demonstration server 704.

Referring to FIGS. 4 and 5, while continuing to refer generally to FIG. 7, one embodiment of a method 400 for providing more reliable output when conducting a live product demonstration is illustrated. As shown, a client (i.e., a client interface 600) initially sends 402 a request to perform a particular function in association with a live product demonstration. The client agent 602 receives 404 the request and forwards 404 the request to the server agent 604. The server agent 604 then invokes 406 the function maintain system 606 to check the server information table 302 for a status of the live demonstration server 704. If, at step 408, the live demonstration server 704 is available, the function maintain system 606 executes 410 the function on the live demonstration server 704. If, at step 412, the execution is successful, the function maintain system 606 returns 414 completion to the server agent 604, which in turn returns 414 to the client agent 602, which in turn returns 414 completion to the client interface 600. The function maintain system 606 may also execute 416 the function on the standby demonstration server 706 if possible and save 416 the function to the unfinished function list table 312 with the succeed tag 350 marked “yes.” The function may be executed on the standby demonstration server 706 at least partly so that if a future request or function fails in the live demonstration server 704, the standby demonstration server 706 may be at a point where it can pick up execution of the function.

If, at step 408, the live demonstration server 704 is not available or, at step 412, the live demonstration server 704 is not able to successfully execute the function, the method 400 proceeds to the method steps illustrated in FIG. 5. As shown in FIG. 5, if either of the conditions 408, 412 is false, the server agent 604 invokes 500 the function maintain system 606 to check the server information table 302 for the status of the standby demonstration server 706. If the standby demonstration server 706 is available, the function maintain system 606 marks the live demonstration server 704 as unavailable in the server information table 302. The function maintain system 606 also saves 506 function information in the unfinished function list table 312. The function maintain system 606 then executes 508 the function on the standby demonstration server 706. This may be from the beginning of the function if no part of the function executed on the live demonstration server 704 or from a breakpoint if part of the function already executed on the live demonstration server 704.

If, at step 510, the function executed successfully on the standby demonstration server 706, the method 400 returns 514 completion to the server agent 604, which returns 514 completion to the client agent 602, which in turn returns 514 completion to the client interface 600. The function maintain system 606 may then check 516 the server action registry database 300 and take action 516 until the live demonstration server 704 recovers. When the live demonstration server 704 recovers (assuming it recovers at some point), the function maintain system 606 reruns 518 functions listed in the unfinished function list table 312. If these execute successfully, the function maintain system 606 marks 522 the live demonstration server 704 as available in the server information table 302 and changes 522 the succeed tag 350 to “yes.”

If, at either step 502 or step 510, the condition proves false, the method 400 may return 512 an error page or message. The error page may indicate that the function was not able to execute successfully on either the live demonstration server 704 or the standby demonstration server 706. Once the error page is returned 512, the function maintain system 606 may take action until the live demonstration server 704 recovers and, once recovered, attempt to run the functions in the unfinished function list table 312 on the live demonstration server 704. If this is not successful at step 520, the function maintain system 606 may repeat this process until the functions are able to execute on the live demonstration server 704. Once the functions execute successfully on the live demonstration server 704, the function maintain system 606 marks 522 the live demonstration server 704 as available and changes 522 the succeed tag 350 for these functions to “yes” in the server information table 302.

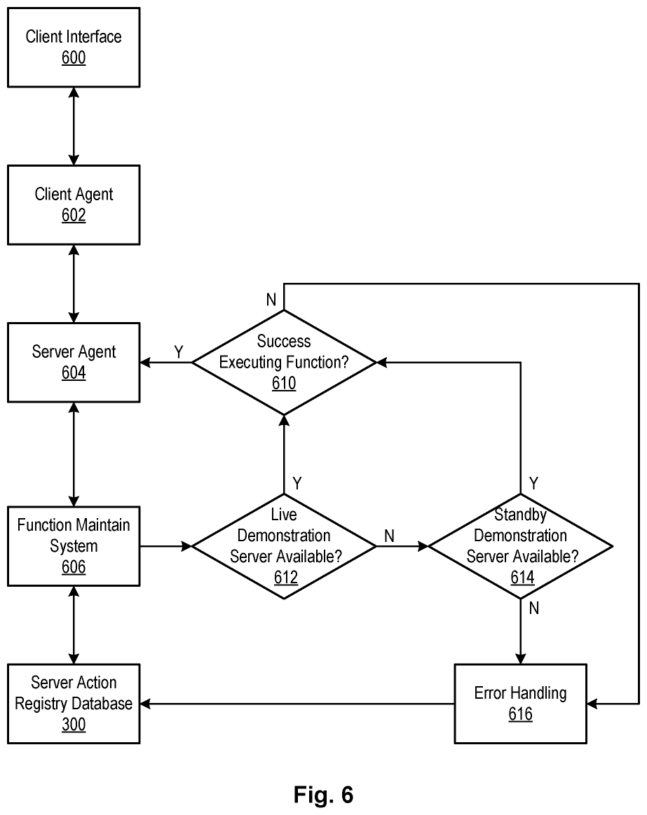

FIG. 6 provides a more simplified or generalized version of the method 400 of FIGS. 4 and 5, showing a process flow or communication between various components or functions of a system 710 in accordance with the invention. As shown, the client interface 600 makes a request to execute a function associated with live product demonstration. The client interface 600 makes the request to the client agent 602 which in turn transmits the request to the server agent 604. The client agent 602 invokes the function maintain system 606 which accesses the server action registry database 300. If the live demonstration server 704 is available at step 612, the function maintain system 606 invokes the live demonstration server 704 to execute the function. If the live demonstration server 704 successfully executes the function at step 610, the function maintain system 606 returns a response to the server agent 604 which in turn returns a response to the client agent 602 and then on to the client interface 600.

If the live demonstration server 704 is not available at step 612 (or if the live demonstration server 704 is not successful in executing the function), a determination is made at step 614 as to the availability of the standby demonstration server 706. If the standby demonstration server 706 is available, the function maintain system 606 invokes the standby demonstration server 706 to execute the function. If the standby demonstration server 706 is successful at executing the function at step 610, the function maintain system 606 returns a response to the server agent 604 which in turn returns a response to the client agent 602 and then on to the client interface 600. If the standby demonstration server 706 is not successful in executing the function, error handling 616 may be invoked. Error handling 616 may include, for example, returning an error message or page to the client interface 600 and/or storing the function in the unfinished function list table 312 until it can be successfully executed by the live demonstration server 704.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for conducting a live product demonstration, the method comprising:
initiating, on a client system, a live product demonstration on a client interface by executing a function on a live demonstration server;
saving a breakpoint associated with the function;
executing the function on a standby demonstration server to prepare for possible failure of the live demonstration server;
determining that the live product demonstration has experienced a failure on the live demonstration server;
checking the availability of the standby demonstration server; and
determining that the standby demonstration server is available, and automatically continuing, from the breakpoint, the live product demonstration on the client interface by continuing execution of the function on the standby demonstration server of the client system.

2. The method of claim 1, further comprising, in the event the live
demonstration server is recovered, resuming the live product demonstration by continuing execution of the function on the live demonstration server.

3. The method of claim 1, wherein checking the availability of the standby demonstration server comprises checking a server action registry database for the availability of the standby demonstration server.

4. The method of claim 1, further comprising, in response to determining that the standby demonstration server is not available, returning an error message to the client system.

5. The method of claim 1, wherein the client system connects to at least one of the live demonstration server and the standby demonstration server over the Internet.

6. The method of claim 1, wherein saving the breakpoint further comprises saving context information associated with the breakpoint.

7. The method of claim 1, wherein the live product demonstration involves both input and output through the client interface at the client system.

8. A computer program product for conducting a live product demonstration, the computer program product comprising a computer-readable storage medium having computer-usable program code embodied therein, the computer-usable program code configured to perform the following when executed by at least one processor:
initiate, on a client system, a live product demonstration on a client interface by executing a function on a live demonstration server;
saving a breakpoint associated with the function;
execute the function on a standby demonstration server to prepare for possible failure of the live demonstration server;
determining that the live product demonstration has experienced a failure on the live demonstration server;
check the availability of the standby demonstration server; and
determine that the standby demonstration server is available, and automatically continue, from the breakpoint, the live product demonstration on the client interface by continuing execution of the function on the standby demonstration server of the client system.

9. The computer program product of claim 8, wherein the computer-usable program code is further configured to, in the event the live demonstration server is recovered, resume the live product demonstration by continuing execution of the function on the live demonstration server.

10. The computer program product of claim 8, wherein checking the availability of the standby demonstration server comprises checking a server action registry database for the availability of the standby demonstration server.

11. The computer program product of claim 8, wherein the computer-usable program code is further configured to, in response to determining that the standby demonstration server is not available, return an error message to the client system.

12. The computer program product of claim 8, wherein the client system connects to at least one of the live demonstration server and the standby demonstration server over the Internet.

13. The computer program product of claim 8, wherein saving the breakpoint further comprises saving context information associated with the breakpoint.

14. The computer program product of claim 8, wherein the live product demonstration involves both input and output though the client interface at the client system.

15. A system for a live product demonstration, the system comprising:
at least one processor; and
at least one memory device operably coupled to the at least one processor and storing instructions for execution on the at least one processor, the instructions causing the at least one processor to:
initiate, on a client system, a live product demonstration on a client interface by executing a function on a live demonstration server;
saving a breakpoint associated with the function;
execute the function on a standby demonstration server to prepare for possible failure of the live demonstration server;
determine that the live product demonstration has experienced a failure on the live demonstration server, save a breakpoint associated with the live product demonstration;
check the availability of the standby demonstration server; and
determine that the standby demonstration server is available, and automatically continue, from the breakpoint, the live product demonstration on the client interface by continuing execution of the function on the standby demonstration server of the client system.

16. The system of claim 15, wherein the instructions further cause the at least one processor to, in the event the live demonstration server is recovered, resume the live product demonstration by continuing execution of the function on the live demonstration server.

17. The system of claim 15, wherein checking the availability of the standby demonstration server comprises checking a server action registry database for the availability of the standby demonstration server.

18. The system of claim 15, wherein the instructions further cause the at least one processor to, in response to determining that the standby demonstration server is not available, return an error message to the client system.

19. The system of claim 15, wherein the client system connects to at least one of the live demonstration server and the standby demonstration server over the Internet.

20. The system of claim 15, wherein saving the breakpoint further comprises saving context information associated with the breakpoint.
